(19) United States
(12) Patent Application Publication
(10) Pub. No.: US 2009/0237713 A1
(43) Pub. Date: Sep. 24, 2009

(54) Print managing apparatus, print managing method, and program

(76) Inventors: Ryu Ebisawa, Yokohama (JP); Yasuhiro Fujii, Sagamihara (JP); Yutaka Tagawa, Yokohama (JP); Akira Morita, Yokohama (JP); Takuya Kusunoki, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/379,640

(22) Filed: Feb. 26, 2009

(30) Foreign Application Priority Data
Mar. 24, 2008 (JP) 2008-076190

(51) Int. Cl. G06F 3/12

(52) U.S. Cl. 358/1.15

(57) ABSTRACT

A print managing apparatus is provided, which is able to reduce the possibility of information leakage due to the printed material, without implementing a new function in the network printer. When there is a directive to perform printing, the print managing apparatus generates a release key, incorporates the generated release key in the print data, and transfers the print data to the network printer. Then, the print managing apparatus displays on the display device, a screen prompting for a release key that corresponds to the release key, which is printed on a printed medium together with the print data.

### INCORPORATION BY REFERENCE

This application claims priority based on a Japanese patent application, No. 2008-076190 filed on Mar. 24, 2008, the entire contents of which are incorporated herein by reference.

### BACKGROUND

The present invention relates to a technique to prevent an information leakage due to a printed material which is printed by a network printer shared by more than one user.

Japanese Patent Laid-open Publication No. H11-296327 discloses a technique that printing can be started only when an intended recipient of a printed material operates the printer, thereby reducing the possibility of information leakage, such as carrying away the printed material or stealing a glance at the printed material. More in detail, when the user directs printing of a document, a user computer generates an authentication key, transmits to a print server the generated authentication key together with the print data, and the user is also notified of the authentication key.

When the user inputs a key in the printer, the printer transmits the key being inputted to the print server. Upon accepting the key from the printer, the print server compares the key, with the authentication key that the print server has accepted from the user computer together with the print data, and if the key matches the authentication key, the print data associated with the authentication key is allowed to be printed from the printer.

### SUMMARY OF THE INVENTION

In order to employ the method disclosed in the Japanese Patent Laid-open Publication No. H11-296327, the printer has to be provided with a function to accept the key and transmit the accepted key to the print server. Some existing printers are ready for implementing this kind of additional function, just by adding software, but if there is no hardware to accept data which is inputted from the user, modification or exchange of the existing printer may be required in certain instances.

If the possibility of information leakage can be reduced, such as carrying away a printed material or stealing a glance at the printed material, while continuing to use the already existing network printer, it is highly convenient for the user, from the viewpoints of both information security and cost.

The present invention has been made in view of the circumstances above, and the present invention provides a technique to reduce the possibility of information leakage due to the printed material, without implementing a new function in the network printer.

In order to solve the problem above, a print managing apparatus of the disclosed system is directed to displaying a screen which prompts for information obtained from the printed material, after the printing is executed.

By way of example, a first aspect of the disclosed system is directed to a printing managing apparatus for allowing a network printer to perform printing of print data indicated by a user, including, a release key generation unit for generating a release key when the user directs printing of the print data, a print directive unit for giving a directive to the network printer to print the release key generated by the release key generation unit, together with the print data indicated by the user, and a display control unit for displaying on a display device an input screen prompting for the release key, after the print directive unit directs the network printer to print the print data and the release key, displaying the input screen again on the display device when a data inputted by the user is different from the release key generated by the release key generation unit, and canceling to display the input screen when the data inputted by the user matches the release key generated by the release key generation unit.

As thus described, the print managing apparatus continues to display the input screen that prompts for the release key, until the release key printed on a printed material is inputted, the user is kept reminded of a collection of the printed material, until it is collected eventually. In other words, the print managing apparatus is able to urge the user to collect the printed material immediately.

A second aspect of the disclosed system is directed to a print managing method in a print managing apparatus for allowing a network printer to perform printing of print data indicated by a user, including the steps of, generating a release key when the user directs the print managing apparatus to print the print data, directing the network printer to print the release key being generated, together with the print data indicated by the user, and displaying on a display device, an input screen prompting for the release key, displaying the input screen again on the display device when a data inputted by the user is different from the release key being generated, and canceling to display the input screen when the data inputted by the user matches the release key being generated.

A third aspect of the disclosed system is directed to a program for allowing a computer to function as a print managing apparatus that allows a network printer to perform printing of print data indicated by a user, the program allowing the computer to implement, a release key generating function for generating a release key when a user directs printing the print data, a print directive function for directing the network printer to print the release key generated by the release key generating function, together with the print data indicated by the user, and a display control function for displaying on a display device an input screen prompting for the release key, after the print directive function directs the network printer to print the print data and the release key, displaying the input screen again on the display device when a data inputted by the user is different from the release key generated by the release key generating function, and canceling to display the input screen when the data inputted by the user matches the release key generated by the release key generating function.

According to the print managing apparatus of the teaching herein, it is possible to reduce the possibility of information leakage caused by the printed material, without installing a new function on the network printer.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 illustrates a system configuration of one example of the print system according to one embodiment of the present invention;

FIG. 2 is a block diagram showing one example of functional configuration of the print managing apparatus according to the first embodiment;

FIG. 3 illustrates one example of data structure that is stored in the print data storage according to the first embodiment;

FIG. 4 is a conceptual diagram showing one example of the release key input screen according to the first embodiment;

FIG. 5 is a conceptual diagram showing one example of the master release key input screen;

FIGS. 6A and 6B conceptually illustrate the timing for displaying the release key input screen;

FIG. 7 is a flow chart showing one example of the print processing according to the first embodiment;

FIG. 8 is a flow chart showing one example of the process for displaying the release key input screen according to the first embodiment;

FIG. 9 is a conceptual diagram showing one example of the release key input screen according to the second embodiment;

FIG. 10 is a flow chart showing one example of the processing for displaying the release key input screen according to the second embodiment;

FIG. 11 is a block diagram showing one example of functional configuration of the print managing apparatus according to the third embodiment;

FIG. 12 illustrates one example of data structure that is stored in the image data storage;

FIG. 13 illustrates one example of data structure that is stored in the print data storage according to the third embodiment;

FIG. 14 is a conceptual diagram showing one example of the release key input screen according to the third embodiment;

FIG. 15 is a block diagram showing one example of functional configuration of the print managing apparatus according to the fourth embodiment;

FIG. 16 illustrates one example of data structure that is stored in the print data storage according to the fourth embodiment;

FIG. 17 is a conceptual diagram showing one example of the batch print managing screen;

FIG. 18 is a conceptual diagram showing one example of the release key input screen according to the fourth embodiment;

FIG. 19 is a flow chart showing one example of the print processing according to the fourth embodiment;

FIG. 20 is a flow chart showing one example of the process for managing the release key input screen; and

FIG. 21 illustrates one example of hardware configuration of the computer which implements the functions of the print managing apparatus.

### DESCRIPTION OF THE EMBODIMENTS

Initially, a first embodiment of the present invention will be explained.

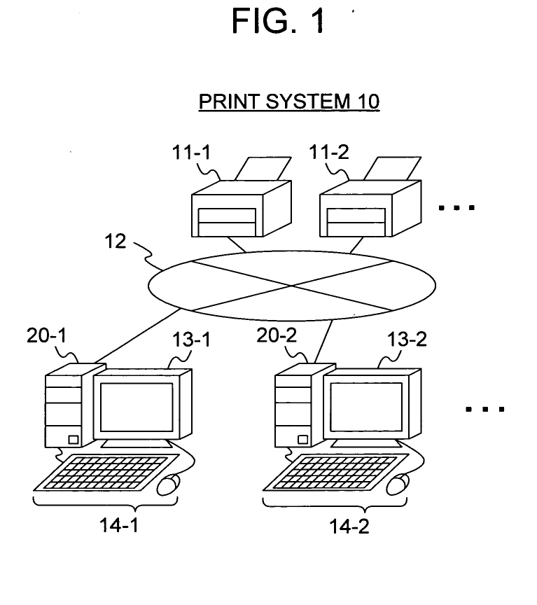

FIG. 1 is a system configuration diagram showing one example of a print system 10 relating to the first embodiment of the present invention. The print system 10 is provided with multiple network printers 11, and multiple print managing apparatuses 20.

Each of the network printers 11 and the print managing apparatuses 20 is coupled to a communication line 12. Each of the print managing apparatus 20 is implemented by a general-purpose computer, and it is coupled to a display device 13 such as an Liquid Crystal Display (LCD), and an input device 14 such as a keyboard or a mouse.

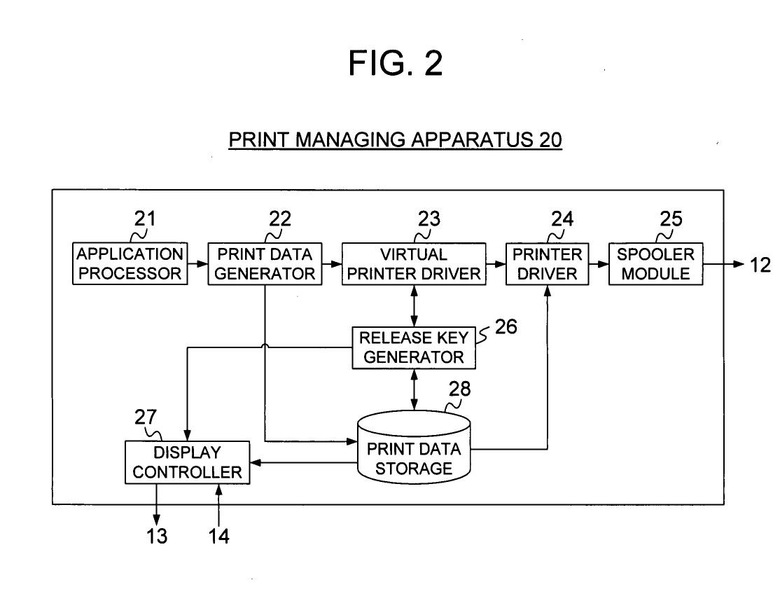

FIG. 2 is a block diagram showing one example of the print managing apparatus 20 according to the first embodiment. The print managing apparatus 20 is provided with an application processor 21, a print data generator 22, a virtual printer driver 23, a printer driver 24, a spooler module 25, a release key generator 26, a display controller 27, and a print data storage 28.

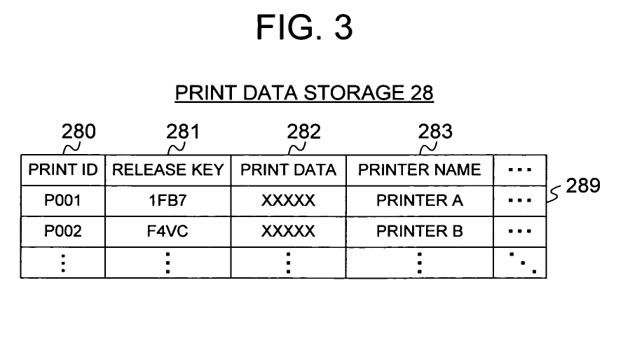

As shown in FIG. 3, for example, a record 289 is recorded in the print data storage 28, when a user directs printing. Each record 289 stores items such as a print ID 280 for identifying each print job, a release key 281 to be used to cancel displaying a release key input screen described below, print data 282, and a printer name 283 being a name of the network printer 11 that is used for printing the print data 282.

The print data storage 28 stores in advance a master release key that is managed by a manger or the like, of the print system 10. In addition, the print data storage 28 may store information relating to the printing, such as a file name as a source of the print data, the number of copies, the number of print pages, and a paper size.

The application processor 21 executes software which implements functions such as a word processor, a spreadsheet, or an image editor, and outputs document data, image data, or the like being generated, to the print data generator 22, in response to a directive from the user.

The print data generator 22 is implemented by a graphic engine as standard equipment of an Operating System (OS), and converts data outputted from the application processor 21 into print data. Then, the print data generator 22 generates a print ID, stores the print data obtained after conversion in the print data storage 28, in association with the print ID being generated. Thereafter, the print data generator 22 generates a drawing command including the print ID being generated, and sends the drawing command to the virtual printer driver 23.

Upon receipt of the drawing command from the print data generator 22, the virtual printer driver 23 sends the drawing command being received to the release key generator 26. Then, when the drawing command is received from the release key generator 26, the virtual printer driver 23 sends the drawing command being received to the printer driver 24.

The virtual printer driver 23 has a function to control a destination of the drawing command, and the Japanese Patent Laid-open Publication No. 2005-182486, for example, discloses the details of this function. In the print managing apparatus 20 of the present embodiment, the virtual printer driver 23 is provided, in order to avoid changes in printing environment which has been already established in a general-purpose computer or the like as much as possible.

According to another aspect of the present embodiment, it is possible to configure such that the print managing apparatus 20 is not provided with the virtual printer driver 23. In this configuration, the release key generator 26 receives the drawing command outputted from the print data generator 22, and after executing a certain processing, the release key generator 26 outputs the drawing command to the printer driver 24.

Upon receipt of the drawing command from the virtual printer driver 23, the printer driver 24 acquires from the print data storage 28, the print data being associated with the print ID included in the drawing command. The printer driver 24 converts the drawing command into a printer description language which can be interpreted by the network printer 11 as an output destination of the print data, and generates a print job including the print data to be printed. The printer driver 24 is produced and provided by a manufacturer or the like of the network printer 11, for instance.

The spooler module 25 is a module, which is, for example, installed in the OS as standard equipment for accumulating the print job generated by the printer driver 24, and transmits the print jobs being accumulated to the network printer 11, via the communication line 12. The printer driver 24 and the spooler module 25 correspond to the print directive unit in the present invention.

In receipt of the drawing command from the virtual printer driver 23, the release key generator 26 generates a release key, and stores the release key being generated in the print data storage 28, in association with the print ID included in the drawing command. Then, the release key generator 26 acquires from the print data storage 28, the print data associated with the print ID, processes the print data in such a manner that the release key being generated and the print ID are printed together with the print data, and overwrites the print data stored in the print data storage 28 by the processed print data.

There are several methods for processing the print data, including for example, a method for processing the print data to print the release key and the print ID on a margin of all or a part of pages of the printed material, a method for processing the print data so that firstly a printed material with the release key and the print ID being printed thereon is printed, and subsequently the target print data is printed, and a method for processing the print data so that firstly the target print data is printed, and subsequently, the printed material with the release key and the print ID being printed thereon is printed.

When the release key and the print ID are printed separately from the target printed material, the first page or the last page of the target printed material can be covered by the printed material on which the release key and the print ID are printed, thereby preventing the contents of the first or the last page of the target printed material from being exposed to other people. When the printed material with the release key and the print ID being printed is printed out after the target print data is printed, it is possible to avoid left-behind pages of the target printed material.

After overwriting the print data stored in the print data storage 28 by the processed print data, the release key generator 26 outputs to the virtual printer driver 23, the drawing command including the print ID associated with this print data. Then, the release key generator 26 notifies the display controller 27 that printing is now started, together with the print ID included in the drawing command that is outputted to the virtual printer driver 23.

The display controller 27 waits for a predetermined period of time (e.g., ten seconds), after it is notified from the release key generator 26 about the print ID and the start of printing. This period of time is assumed to be the time from when the user directs printing until when he or she collects the printed material and gets back to his or her desk, for instance. This time period is set in advance by a manager of the print system 10 or the user of the print managing apparatus 20. It is to be noted that this time period may be set to be zero.

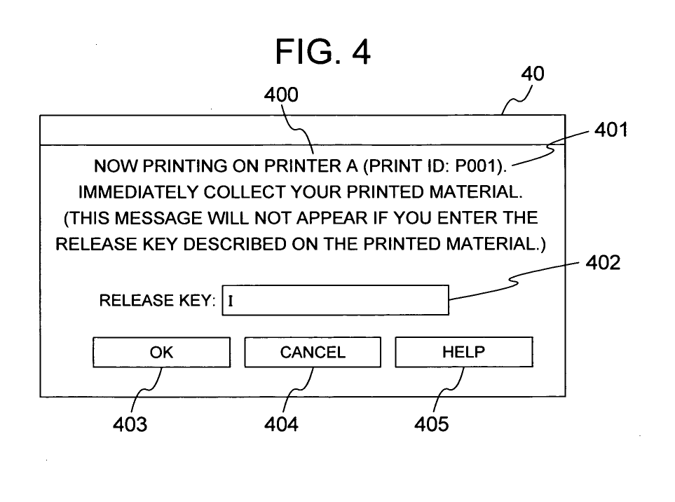

After the lapse of the predetermined period of time (ten seconds, for example), the display controller 27 acquires from the print data storage 28, the printer name as an output destination, associated with the print ID that is notified from the release key generator 26, and displays a release key input screen 40 on the display device 13, as shown in FIG. 4, for instance. The release key input screen 40 is displayed at the forefront, having a certain size with respect to the display area of the display device 13, over the other working window or windows. Such displaying feature can be implemented by using SetWindowPos function which is standard equipment of Windows (registered trademark).

In the release key input screen 40 as shown in FIG. 4, the printer name as the output destination is displayed in the area 400 and the print ID is displayed in the area 401. After data is inputted into the input area 402 via the input device 14 and the OK button 403 is pressed via the input device 14, the display controller 27 acquires from the print data storage 28 the release key associated with the print ID being displayed in the area 401, and compares the release key with the data inputted in the input area 402.

If the release key acquired from the print data storage 28 matches the data being inputted in the input area 402, the display controller 27 displays information that a valid release key is entered, and cancels to display the release key input screen 40. On the other hand, if the release key acquired from the print data storage 28 is different from the data inputted in the input area 402, the display controller 27 displays on the display device 13 information indicating that the valid release key is not entered, and displays the release key input screen 40 again on the display device 13.

In the release key input screen 40 as shown in FIG. 4, when the cancel button 404 is pressed via the input device 14, the display controller 27 temporarily cancels to display the release key input screen 40, and after lapse of a predetermined period of time, the release key input screen 40 is displayed again at the forefront.

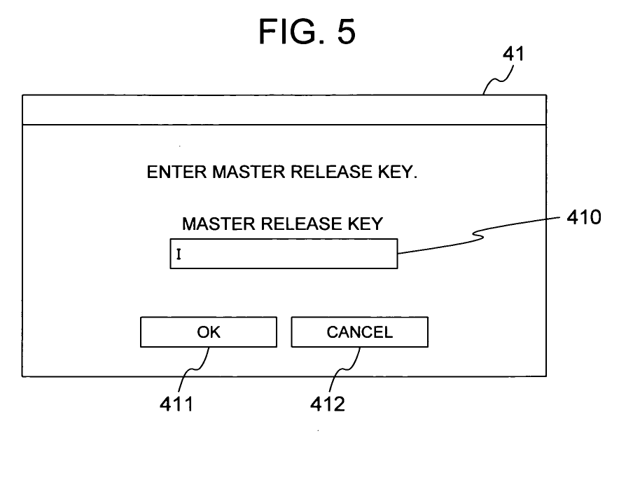

Further in the release key input screen 40 as shown in FIG. 4, when the help button 405 is pressed via the input device 14, the display controller 27 displays a master release key input screen 41 as shown in FIG. 5, for instance, as a working window having a predetermined size with respect to the display area of the display device 13, at the forefront over the other window or windows.

In the master release key input screen 41 as shown in FIG. 5, after data is inputted in the input area 410 via the input device 14, and the OK button 411 is pressed via the input device 14, the display controller 27 acquires the master release key from the print data storage 28, and compares the master release key with the data inputted in the input area 410. When the master release key matches the data inputted in the input area 410, the display controller 27 displays information that a valid release key is entered and cancels to display the master release key input screen 41.

On the other hand, when the master release key is different from the data inputted in the input area 410, or there is no input from the user for a predetermined period of time, the display controller 27 displays the release key input screen 40 again on the display device 13. It is to be noted that the master release key is used to cancel scheduled displaying of the release key input screen 40, in the case where a printed material with the release key being printed thereon has not been outputted from the network printer 11 due to a failure of the network printer 11, such as paper jam.

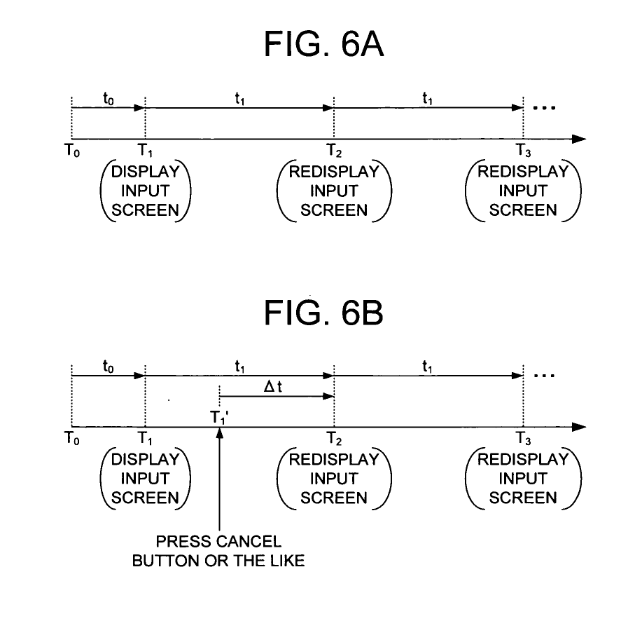

Even after the release key input screen 40 as shown in FIG. 4 is displayed, the user is allowed to continue works, by operating the input device 14 to move the other working window to the forefront over the release key input screen 40. However, the display controller 27 redisplays the release key input screen 40 shown in FIG. 4 at the forefront, at predetermined intervals, until the valid release key is entered. FIG. 6A is an example of the timing for displaying the release key input screen 40.

The display controller 27 displays the release key input screen 40 at the forefront, at the point of T₁ after a lapse of to (ten seconds, for instance) from T₀ when the information indicating the print start together with the print ID is notified from the release key generator 26. Afterwards, the display controller 27 redisplays the release key input screen 40 at the forefront, at intervals of t₁ (thirty seconds, for instance).

Further as shown in FIG. 6B, after the release key input screen 40 is displayed at T₁, if the cancel button is pressed at T₁′, or if there is no user input even after the help button is pressed and the master release key input screen 41 is displayed, the display controller 27 redisplays the release key input screen 40 at the forefront at T₂ after a lapse of Δt.

As thus described, the display controller 27 continues to display the release key input screen 40 at the forefront at regular time intervals, until the release key being printed on the printed material is inputted. Therefore, the user is kept reminded of collecting the printed matter, until it is collected eventually. In other words, it is possible for the print managing apparatus 20 to urge the user to collect the printed material immediately.

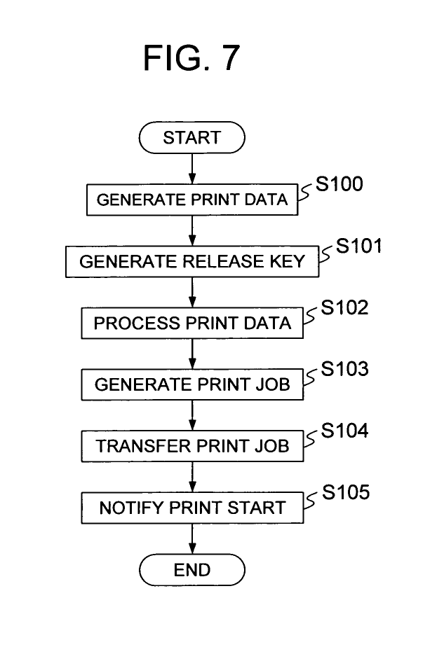

FIG. 7 is a flow chart showing an example of the print processing according to the first embodiment. In the case where the application processor 21 accepts a directive for printing from the user via the input device 14, the print managing apparatus 20 starts operations as shown in the flow chart.

Firstly, the application processor 21 outputs generated data such as document data or image data to the print data generator 22, according to the directive from a user. The print data generator 22 converts the data outputted from the application processor 21 into print data, thereby generating the print data (S100). Then, the print data generator 22 generates a print ID, and stores the print data in the print data storage 28 in association with the print ID. The print data generator 22 generates a drawing command including the print ID being generated, and sends the drawing command to the virtual printer driver 23.

Next, the virtual printer driver 23 sends the drawing command received from the print data generator 22, to the release key generator 26. Then, the release key generator 26 generates a release key (S101), and stores the generated release key in the print data storage 28, in association with the print ID that is included in the drawing command received from the virtual printer driver 23.

Next, the release key generator 26 acquires the print data associated with the print ID, from the print data storage 28, processes the print data so that the generated release key and print ID are printed together with the print data (S102), and overwrites the print data stored in the print data storage 28 by the processed print data. Then, the release key generator 26 outputs to the virtual printer driver 23, a drawing command including the print ID associated with the print data that has been overwritten. The virtual printer driver 23 sends the drawing command received from the release key generator 26 to the printer driver 24.

Next, the printer driver 24 acquires from the print data storage 28, the print data associated with the print ID that is included in the drawing command received from the virtual printer driver 23. Then, the printer driver 24 converts the drawing command into a printer description language that can be interpreted by the network printer 11 as an output destination of the print data, generates a print job including the print data to be printed (S103), and sends the print job being generated to the spooler module 25.

Next, the spooler module 25 accumulates print job received from the printer driver 24, and transfers the accumulated print jobs to the network printer 11, via the communication line 12 (S104). Then, the release key generator 26 notifies the display controller 27 of the information indicating that printing is started, together with the print ID included in the drawing command that is outputted to the virtual printer driver 23 (S105), and the print managing apparatus 20 completes the print processing indicated in the flow chart.

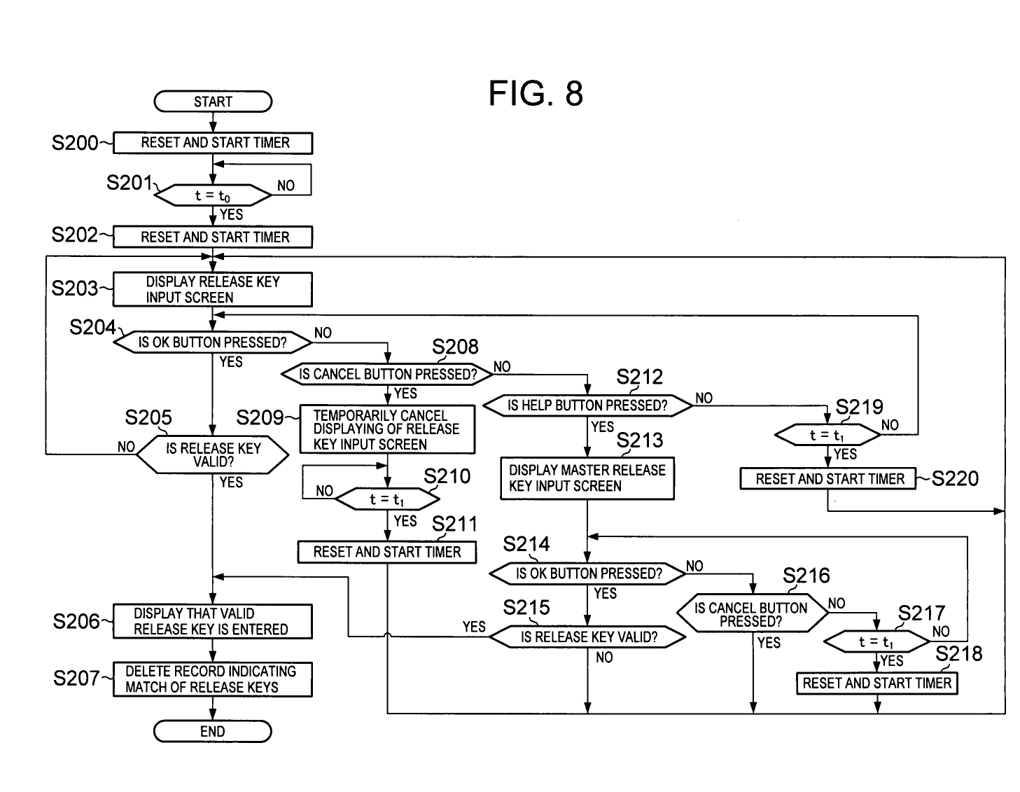

FIG. 8 is a flow chart showing one example of displaying process of the release key input screen, which is executed by the display controller 27 in the first embodiment. In step S105 of FIG. 7, when the release key generator 26 notifies the start of printing, together with the print ID, the display controller 27 starts the operations as shown in the flow chart.

Firstly, the display controller 27 resets and starts a timer within the print managing apparatus 20 (S200), and determines whether or not a value t of the timer becomes a predetermined value to (ten seconds, for instance) (S201). When the value t of the timer has become the predetermined value to (S201: Yes), the display controller 27 resets and starts the timer (S202), and the display controller 27 displays the release key input screen 40 illustrated in FIG. 4 at the forefront (S203).

Next, the display controller 27 determines whether or not the OK button 403 is pressed in the release key input screen 40 (S204). If the OK button 403 is pressed (S204: Yes), the display controller 27 acquires from the print data storage 28, a release key being associated with the print ID that is displayed on the release key input screen 40, and compares the release key with the data inputted in the input area 402 of the release key input screen 40, thereby determining whether or not a valid release key is entered (S205).

If the release key acquired from the print data storage 28 is different from the data inputted in the input area 402 of the release key input screen 40, in other words, if the valid release key is not entered (S205: No), the display controller 27 displays on the display device 13 information indicating that the valid release key is not entered, and executes again the process shown in step S203.

On the other hand, if the release key acquired from the print data storage 28 matches the data inputted in the input area 402 of the release key input screen 40, in other words, if the valid release key is entered (S205: Yes), the display controller 27 displays on the display device 13 information indicating that the valid release key is entered (S206). Then, the display controller 27 deletes from the print data storage 28, the record 289 whose release key indicates the match (S207). Then, the display controller 27 completes the process for displaying the release key input screen as shown in the flow chart.

If the OK button 403 is not pressed in the release key input screen 40 (S204: No), the display controller 27 determines whether or not the cancel button 404 is pressed in the release key input screen 40 (S208). When the cancel button 404 is pressed (S208: Yes), the display controller 27 temporarily cancels to display the release key input screen 40 (S209).

Next, the display controller 27 determines whether or not the value t of the timer has become a predetermined value t₁ (thirty seconds, for example) (S210). When the value t of timer has become the predetermined value t₁ (S210: Yes), the display controller 27 resets and starts the timer (S211), and again executes the process as shown in step S203.

If the cancel button 404 is not pressed in the release key input screen 40 (S208: No), the display controller 27 determines whether or not the help button 405 is pressed in the release key input screen 40 (S212). If the help button 405 is pressed (S212: Yes), the display controller 207 displays at the forefront, the master release key input screen 41 as described with FIG. 5 (S213).

Next, the display controller 27 determines whether or not the OK button 411 is pressed in the master release key input screen 41 (S214). If the OK button 411 is pressed (S214: Yes), the display controller 27 acquires the master release key from the print data storage 28, and determines whether or not a valid release key is entered by comparing the master release key with the data inputted in the input area 410 of the master release key input screen 41 (S215).

If the master release key acquired from the print data storage 28 is different from the data inputted in the input area 410 of the master release key input screen 41, in other words, if the valid release key is not entered (S215: No), the display controller 27 displays on the display device 13 information indicating that the valid release key is not entered, and executes again the process as shown in step S203.

On the other hand, when the master release key acquired from the print data storage 28 matches the data inputted in the input area 410 of the master release key input screen 41, in other words, when the valid release key is entered (S215: Yes), the display controller 27 executes the process shown in step S206.

When the OK button 411 is not pressed in the master release key input screen 41 (S214: No), the display controller 27 determines whether or not the cancel button 412 is pressed in the master release key input screen 41 (S216). If the cancel button 412 is pressed (S216: Yes), the display controller 27 executes again the process shown in step S203.

If the cancel button 412 is not pressed in the master release key input screen 41 (S216: No), the display controller 27 determines whether or not the value t of the timer has become the predetermined value t₁ (S217). If the value t of the timer has not become the predetermined value t₁ yet (S217: No), the display controller 27 executes again the process shown in step S214. When the value t of the timer has become the predetermined value t₁ (S217: Yes), the display controller 27 resets and starts the timer (S218), and executes again the process shown in step S203.

If the help button 405 has not been pressed in the release key input screen 40 (S212: No), the display controller 27 determines whether or not the value t of the timer has become the predetermined value t₁ (S219). If the value t of the timer has not become the predetermined value t₁ yet (S219: No), the display controller 27 executes again the process shown in step S204. When the value t of the time has become the predetermined value t₁ (S219: Yes), the display controller 27 resets and starts the timer (S220), and executes again the process shown in step S203.

In the description above, the first embodiment has been explained.

As is clear from the explanation above, according to the print managing apparatus 20 of the present embodiment, it is possible to urge the user to collect a printed material quickly, without installing a new function in the network printer 11, and it is further possible to reduce the possibility of information leakage due to the printed material.

Next, a second embodiment of the present invention will be explained.

The print managing apparatus 20 according to the present embodiment may be the same as or have similar functions to the print managing apparatus 20 of the first embodiment that is explained with reference to FIG. 2, except the points as described below. Therefore, tedious explanation will not be made.

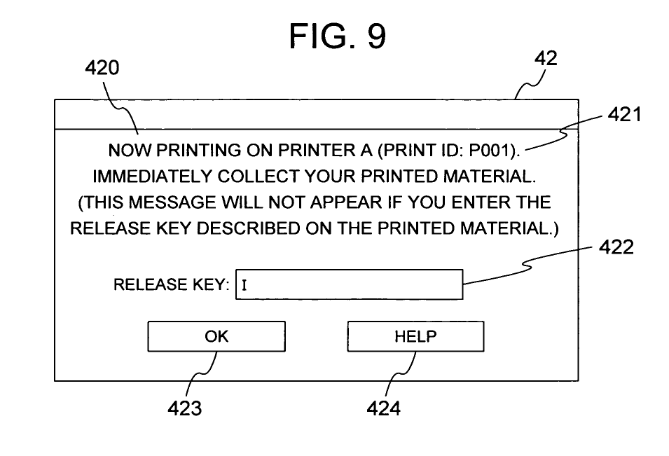

After a lapse of a predetermined period of time from when the start of printing is notified by the release key generator 26 together with the print ID, the display controller 27 according to the present embodiment acquires from the print data storage 28, a printer name as an output destination associated with the print ID. Then, the display controller 27 displays on the display device 13, the release key input screen 42 as shown in FIG. 9, for instance. In the present embodiment, the release key input screen 42 is displayed at the forefront over the other working window or windows, as a working window having a size corresponding to all over the surface of the display area of the display device 13.

In the release key input screen 42 as shown in FIG. 9, the name of the printer as the output destination is displayed in the area 420, and the print ID is displayed in the area 421. After the data is inputted in the input area 422 via the input device 14 and the OK button 423 is pressed via the input device 14, the display controller 27 acquires from the print data storage 28, a release key associated with the print ID that is displayed in the area 421, and compares the release key with the data inputted in the input area 422.

If the release key acquired from the print data storage 28 matches the data inputted in the input area 422, the display controller 27 displays information indicating that a valid release key is entered, and cancels to display the release key input screen 42. On the other hand, if the release key acquired from the print data storage 28 is different from the data inputted in the input area 422, the display controller 27 displays on the display device 13 information indicating that the valid release key is not entered, and displays the release key input screen 42 again on the display device 13.

In the release key input screen 42 as shown in FIG. 9, if the help button 424 is pressed via the input device 14, the display controller 27 displays on the display device 13 the master release key input screen 41 explained with reference to FIG. 5, for instance. In the present embodiment, the cancel button is not displayed on the release key input screen 42.

In the present embodiment, the display controller 27 continues to display the release key input screen 42 as shown in FIG. 9 at the forefront, all over the display area of the display device 13, until the valid release key is entered. Accordingly, it hinders the user from doing works other than operating the release key input screen 42, and the print managing apparatus 20 urges the user to collect the printed material immediately.

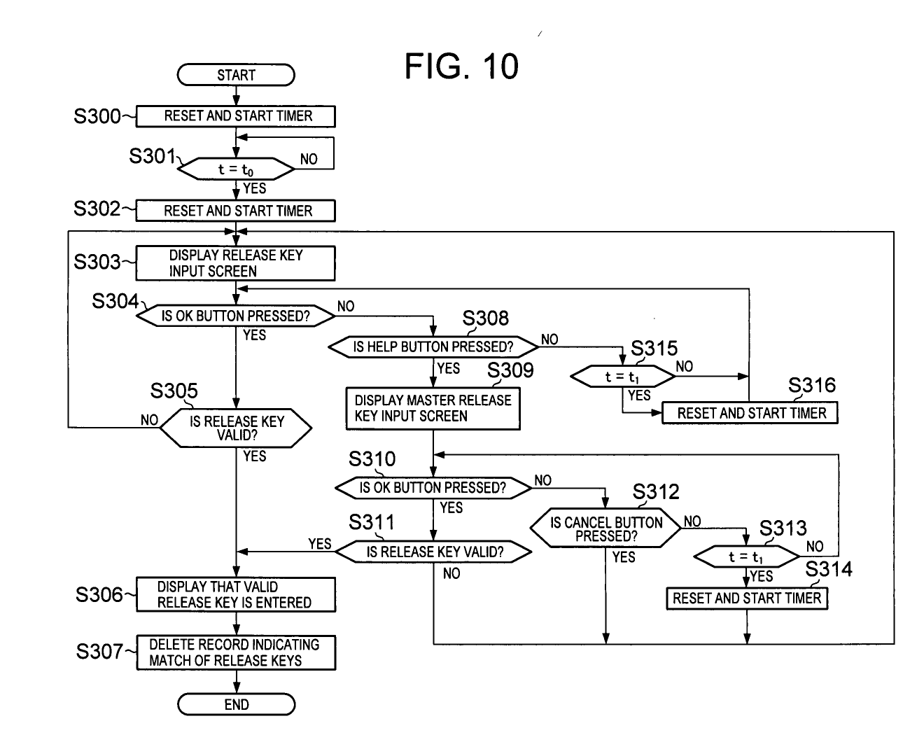

Next, processing of the print managing apparatus 20 according to the present embodiment will be explained. The print processing of the print managing apparatus 20 is the same as the print processing of the first embodiment as explained with reference to FIG. 7. In the second embodiment, FIG. 10 shows a flow chart, for instance, indicating one example of processing for displaying the release key input screen, which is executed by the display controller 27. In step S105 of FIG. 7, when the start of printing together with the print ID is notified from the release key generator 26, the display controller 27 starts operations as shown in the flow chart.

Firstly, the display controller 27 resets and starts the timer within the print managing apparatus 20 (S300), and determines whether or not a value t of the timer has become a predetermined value to (ten seconds, for example) (S301). When the value t of the time has become the predetermined value to (S301: Yes), the display controller 27 resets and starts the timer (S302), and displays the release key input screen 42 as explained with reference to FIG. 9 at the forefront, all over the display area of the display device 13 (S303).

Next, the display controller 27 determines whether or not the OK button 423 has been pressed in the release key input screen 42 (S304). If the OK button 423 is pressed (S304: Yes), the display controller 27 acquires from the print data storage 28, a release key associated with the print ID displayed in the release key input screen 42, compares the release key with the data inputted in the input area 422 of the release key input screen 42, thereby determining whether or not a valid release key is entered (S305).

When the release key acquired from the print data storage 28 is different from the data inputted in the input area 422 of the release key input screen 42, in other words, the valid release key is not entered (S305: No), the display controller 27 displays on the display device 13 information that the valid release key is not entered, and executes again the process shown in step S303.

On the other hand, when the release key acquired from the print data storage 28 matches the data inputted in the input area 422 of the release key input screen 42, in other words, the valid release key is entered (S305: Yes), the display controller 27 displays on the display device 13 information that the valid release key is entered (S306). Then, the display controller 27 deletes from the print data storage 28, a record 289 whose release key indicates the match (S307), and completes the process for displaying the release key input screen as shown in the flow chart.

If the OK button 423 is not pressed in the release key input screen 42 (S304: No), the display controller 27 determines whether or not the help button 424 is pressed in the release key input screen 42 (S308). If the help button 424 is pressed (S308: Yes), the display controller 27 displays at the forefront, the master release key input screen 41 that has been explained with reference to FIG. 5 (S309).

Next, the display controller 27 determines whether or not the OK button 411 is pressed in the master release key input screen 41 (S310). When the OK button 411 is pressed (S310: Yes), the display controller 27 acquires from the print data storage 28 the master release key, and compares the master release key with the data inputted in the input area 410 of the master release key input screen 41, thereby determining whether or not a valid release key is entered (S311).

When the master release key acquired from the print data storage 28 is different from the data inputted in the input area 410 of the master release key input screen 41, in other words, the valid release key is not entered (S311: No), the display controller 27 displays on the display device 13 information that the valid release key is not entered, and executes again the process shown in step S303.

On the other hand, when the master release key acquired from the print data storage 28 matches the data inputted in the input area 410 of the master release key input screen 41, in other words, the valid release key is entered (S311: Yes), the display controller 27 executes the process shown in step S306.

If the OK button 411 is not pressed in the master release key input screen 41 (S311: No), the display controller 27 determines whether or not the cancel button 412 is pressed in the master release key input screen 41 (S312). If the cancel button 412 is pressed (S312: Yes), the display controller 27 executes again the process shown in step S303.

If the cancel button 412 is not pressed in the master release key input screen 41 (S312: No), the display controller 27 determines whether or not the value t of the timer has become a predetermined value t₁ (S313). If the value t of the timer has not become the predetermined value t₁ (S313: No), the display controller 27 executes again the process shown in step S310. When the value t of the timer has become the predetermined value t₁ (S313: Yes), the display controller 27 resets and starts the timer (S314), and executes again the process shown in step S303.

If the help button 424 is not pressed in the release key input screen 42 (S308: No), the display controller 27 determines whether or not the value t of the timer has become the predetermined value t₁ (S315). When the value t of the timer has not become the predetermined value t₁ yet (S315: No), the display controller 27 executes again the processing as shown in step S304. When the value t of the timer has become the predetermined value t₁ (S315: Yes), the display controller 27 resets and starts the timer (S316), and executes again the process shown in step S304.

The second embodiment of the present invention has been explained as described above.

According to the print managing apparatus 20 according to the present embodiment, it is possible to urge the user to immediately collect the printed material.

Next, a third embodiment of the present invention will be explained.

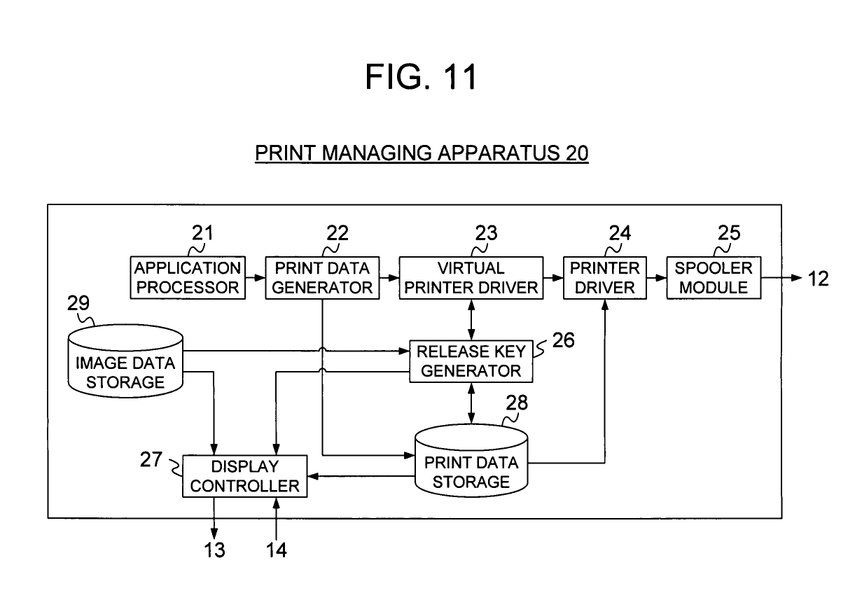

FIG. 11 is a block diagram showing one example of functional configuration of the print management apparatus 20 according to the third embodiment. The print managing apparatus 20 is provided with the application processor 21, the print data generator 22, the virtual printer driver 23, the printer driver 24, the spooler module 25, the release key generator 26, the display controller 27, the print data storage 28, and an image data storage 29. Further in the present embodiment, an image reader is coupled to the print managing apparatus 20. Except the points as explained in the following, the constituent elements in FIG. 11 labeled the same as those in FIG. 2 may be the same as or have similar functions to those in the configuration of FIG. 2. Therefore, tedious explanation will not be made.

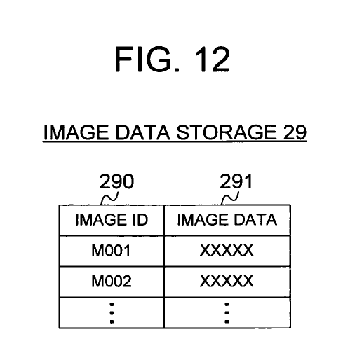

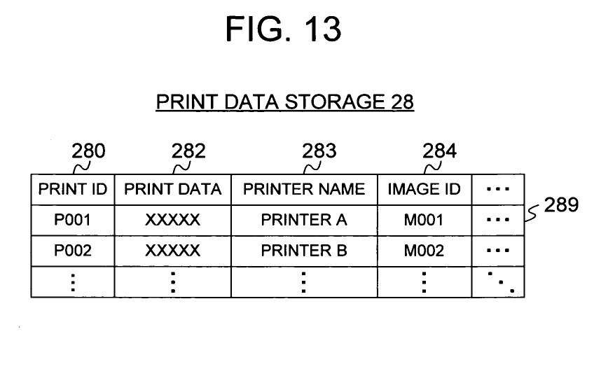

As shown in FIG. 12, for instance, the image data storage 29 stores in advance image data 291 respectively in association with image IDs 290 each for identifying the image data 291. The image data 291 may be characters, graphics, symbols, and a combination thereof, or the like. In the present embodiment, as shown in FIG. 13, each record 289 within the print data storage 28 stores items such as the print ID 280, the print data 282, the printer name 283, and an image ID 284 of the image data that is printed together with the print data.

In receipt of a drawing command from the virtual printer driver 23, the release key generator 26 selects one image ID with reference to the image data storage 29, and stores the selected image ID in the print data storage 28 in association with the print ID included in the drawing command. Then, the release key generator 26 acquires from the print data storage 28 the print data associated with the print ID, and also acquires from the image data storage 29 the image data associated with the selected image ID.

Then, the release key generator 26 processes the print data, in such a manner that the print data acquired from the print data storage 28 is printed out together with an image associated with the image data acquired from the image data storage 29 and the print ID associated with the print data. Then, the release key generator 26 overwrites the print data stored in the print data storage 28, by the print data having been processed.

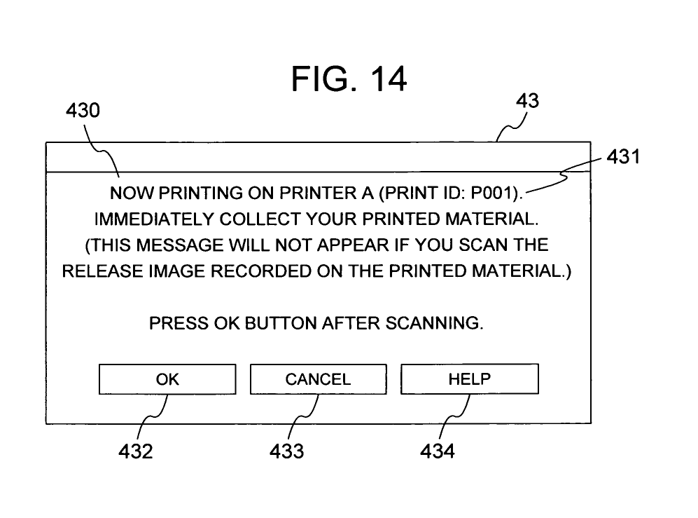

When the start of printing is notified together with the print ID from the release key generator 26, the display controller 27 waits for a predetermined period of time (ten seconds, for instance), acquires from the print data storage 28, a printer name as an output destination in association with the print ID being notified from the release key generator 26, and displays on the display device 13 the release key input screen 43 as shown in FIG. 14. The release key input screen 43 is displayed at the forefront, as a working window having a predetermined size with respect to the display area of the display device 13, over the other working window or windows.

In the release key input screen 43 as shown in FIG. 14, the printer name as an output destination is displayed in the area 430 and the print ID is displayed in the area 431. After the image of the printed material is captured via the image reader coupled to the print managing apparatus 20 and the OK button 432 is pressed via the input device 14, the display controller 27 acquires from the print data storage 28 the image ID in association with the print ID displayed in the area 431. Then, the display controller 27 acquires from the image data storage 29, the image data associated with the image ID being acquired, and compares the image data being acquired with a part of the image data captured via the image reader coupled to the print managing apparatus 20, by a pattern matching or the like, for instance.

If the image data acquired from the image data storage 29 matches the part of the image data captured via the image reader, the display controller 27 displays that a valid release key is entered, and cancels to display the release key input screen 43. On the other hand, if the image data acquired from the image data storage 29 is different from the part of the image data captured via the image reader, the display controller 27 displays on the display device 13 that the valid release key is not entered, and displays again the release key input screen 43 on the display device 13.

In the release key input screen 43 as shown in FIG. 14, if the cancel button 433 is pressed, the display controller 27 temporarily cancels to display the release key input screen 43, and displays again the release key input screen 43 at the forefront after a lapse of a predetermined period of time, as explained with reference to FIG. 6B. In the release key input screen 43 as shown in FIG. 14, if the help button 434 is pressed, the display controller 27 displays on the display device 13 the master release key input screen 41 as explained with reference to FIG. 5.

The third embodiment of the present invention has been explained as described above.

According to the print managing apparatus 20 of the present embodiment, it is necessary for the user to collect the printed material, so as to allow the image reader to read a part of the material. Therefore, this configuration may motivate the user more to collect the printed material.

Next, a fourth embodiment of the present invention will be explained.

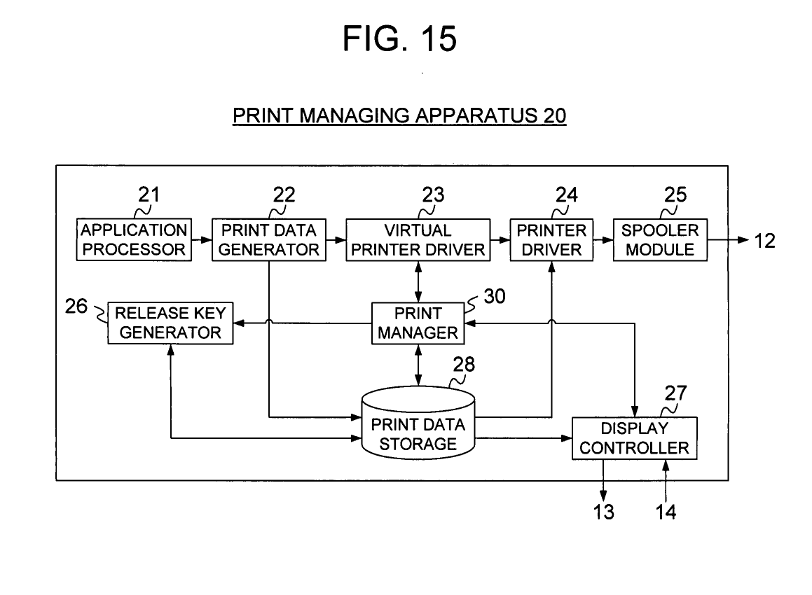

FIG. 15 is a block diagram showing one example of functional configuration of the print managing apparatus 20 according to the fourth embodiment. The print managing apparatus 20 is provided with the application processor 21, the print data generator 22, the virtual printer driver 23, the printer driver 24, the spooler module 25, the release key generator 26, the display controller 27, the print data storage 28, and a print manager 30. Except the points as explained in the following, the constituent elements in FIG. 15 labeled the same as those in FIG. 2 may be the same functions or have similar functions thereto. Therefore, tedious explanation will not be made.

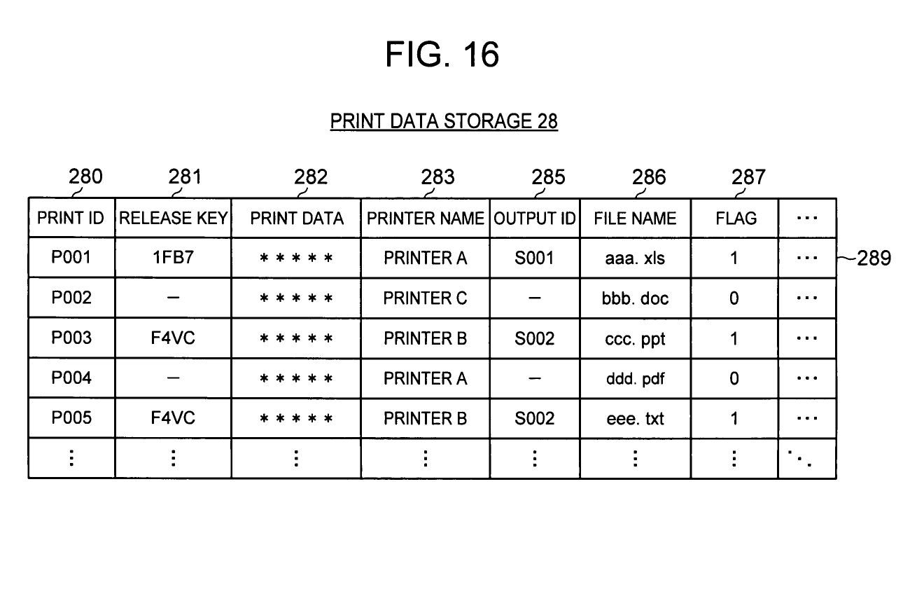

In the present embodiment, as shown in FIG. 16 for instance, each record 289 within the print data storage 28 stores items such as the print ID 280, the release key 281, the print data 282, the printer name 283, an output ID 285 for identifying a set of print data to be printed as a batch, a file name 286 of the file as a source of the print data 282, and a flag 287 indicating whether or not printing has been executed.

In the print data storage 28, the print ID 280, the print data 282, the printer name 283, and the file name 286 are registered by the print data generator 22, and the release key 281 and the output ID 285 are registered by the release key generator 26. Furthermore, in the flag 287, the print data generator 22 sets “0” indicating that the printing has not been executed yet, and the print manager 30 sets “1” indicating that the printing has been executed.

When the virtual printer driver 23 receives a drawing command from the print data generator 22, the virtual printer driver 23 sends the drawing command being received to the print manager 30. On the other hand, when the virtual printer driver 23 receives a drawing command from the print manager 30, the virtual printer driver 23 sends the drawing command being received to the printer driver 24.

Upon receipt of the drawing command from the virtual printer driver 23, the print manager 30 directs the display controller 27 to display a batch print managing screen. If the print manager 30 receives a directive from the display controller 27 to delete data, with information about at least one print ID, the print manager 30 deletes from the print data storage 28, the record 289 including the print ID indicated by the display controller 27.

If the print manager 30 receives a directive from the display controller 27 to perform batch printing, together with information about at least one print ID, the print manager 30 notifies the release key generator 26 of the print ID that is given from the display controller 27. Then, the print manager 30 sets “1” in the flag 287 within the record 289 that includes the print ID indicated by the display controller 27. After the process of the print data is completed by the release key generator 26, the print manager 30 sends to the virtual printer driver 23 the drawing command including the print ID indicated by the display controller 27, and notifies the display controller 27 that printing has started.

After notifying the display controller 27 that printing has started, the print manager 30 refers to the print data storage 28, and determines whether or not the record 289 exists in which “0” is set to the flag 287. If the record 289 exists in which “0” is set to the flag 287, the print manager 30 again directs the display controller 27 to display the batch print managing screen.

When the print ID is notified from the print manager 30, the release key generator 26 refers to the print data storage 28, allocates the notified print ID into a group, the print ID being associated with an identical output destination printer name, and assigns an output ID to each group. Then, the release key generator 26 generates a release key for each group to which the output ID is assigned. The release key generator 26 further registers in the print data storage 28 the output ID being assigned and the release key being generated with respect to each group, in association with the print ID within the group.

Then, the release key generator 26 selects one print ID for each group, acquires from the print data storage 28, the print data associated with the print ID being selected, and processes the print data in such a manner that the release key generated for the group and the output ID assigned to the group are printed together with the print data being acquired.

Then, the release key generator 26 overwrites the pertinent print data within the print data storage 28, by the print data being processed. After the process of the print data is completed for all group generated for the print ID notified from the print manager 30, the release key generator 26 notifies the print manager 30 that the process of the print data has been completed.

As thus described, the release key generator 26 generates the release key for each network printer 11 as an output destination, and prints the release key together with the print data. Therefore, when multiple printed materials are continuously printed by one network printer 11, the user is just required to input one release key for the multiple printed materials being printed by one network printer 11, thereby saving the user time and trouble. In addition, when the release key is printed separately from the printed material, it is possible to reduce the volume of print medium on which the release key is printed.

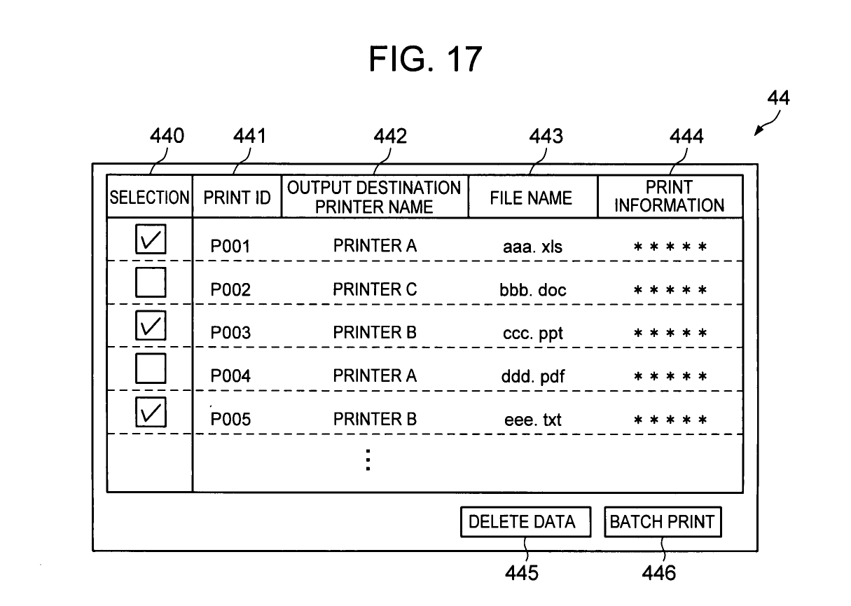

In receipt of a directive from the print manager 30 to display the batch print managing screen, the display controller 27 refers to the print data storage 28, and displays on the display device 13 a batch print managing screen 44 as shown in FIG. 17 for instance, as to the record 289 in which “0” is set to the flag 287. The batch print managing screen 44 displays items such as a check box 440 indicating whether or not a selection is made by the user, the print ID 441, an output destination printer name 442, the file name 443, print information 444 indicating the information relating to the printing, such as the number of copies or the number of pages, a data deletion button 445, and a batch print button 446.

If the data deletion button 445 is selected after the selection of any check box 440 via the input device 14, the display controller 27 directs the print manager 30 to delete the data, together with information about the print ID in association with the check box 440 being selected. If the batch print button 446 is selected after the selection of any check box 440 via the input device 14, the display controller 27 directs the print manager 30 to perform batch printing together with information about the print ID in association with the check box 440 being selected.

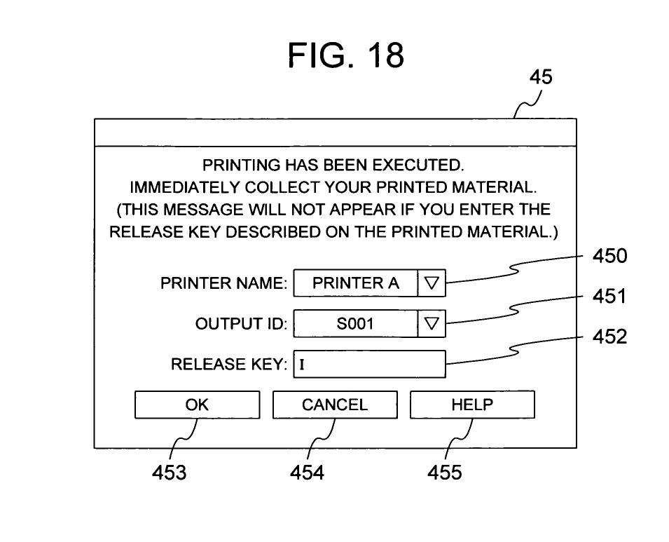

When the start of printing is notified from the print manager 30, the display controller 27 refers to the print data storage 28, and displays on the display device 13 the release key input screen 45 as shown in FIG. 18, as to the record 289 in which “1” is set to the flag 287. The release key input screen 45 is displayed as a working window having a predetermined size with respect to the display area of the display device 13, at the forefront over the other working window or windows.

In the release key input screen 45 as shown in FIG. 18, there are displayed an area 450 showing a pull-down menu where the output destination printer name is stored, an area 451 showing a pull-down menu where the output ID being printed on the printed material is stored, an input area 452 for inputting the release key, an OK button 453, a cancel button 454, and a help button 455.

The user operates the input device 14, so as to select via the pull-down menu of the area 450, the name of the printer from which the printed material is outputted, select via the pull-down menu of the area 451, the output ID printed on the printed material, input the release key printed on the printed material in the area 452, and press the OK button 453.

When the OK button 453 is pressed, the display controller 27 specifies within the print data storage 28, a record including the output ID that is selected via the pull-down menu of the area 451, and extracts the release key included in the specified record. Then, the display controller 27 compares the release key being extracted with the data inputted in the area 452.

Then, if the release key being extracted matches the data inputted in the input area 452, the display controller 27 displays that a valid release key is entered and cancels to display the release key input screen 45. On the other hand, if the release key being extracted is different from the data being inputted in the input area 452, the display controller 27 displays information that the valid release key is not entered, and displays the release key input screen 45 again on the display device 13.

In the release key input screen 45 as shown in FIG. 18, if the cancel button 454 is pressed, the display controller 27 temporarily cancels to display the release key input screen 45, and displays again the release key input screen 45 at the forefront after a lapse of a predetermined period of time as explained with reference to FIG. 6B. In the release key input screen 45 as shown in FIG. 18, if the help button 455 is pressed, the display controller 27 displays on the display device 13 the master release key input screen 41 as explained with reference to FIG. 5.

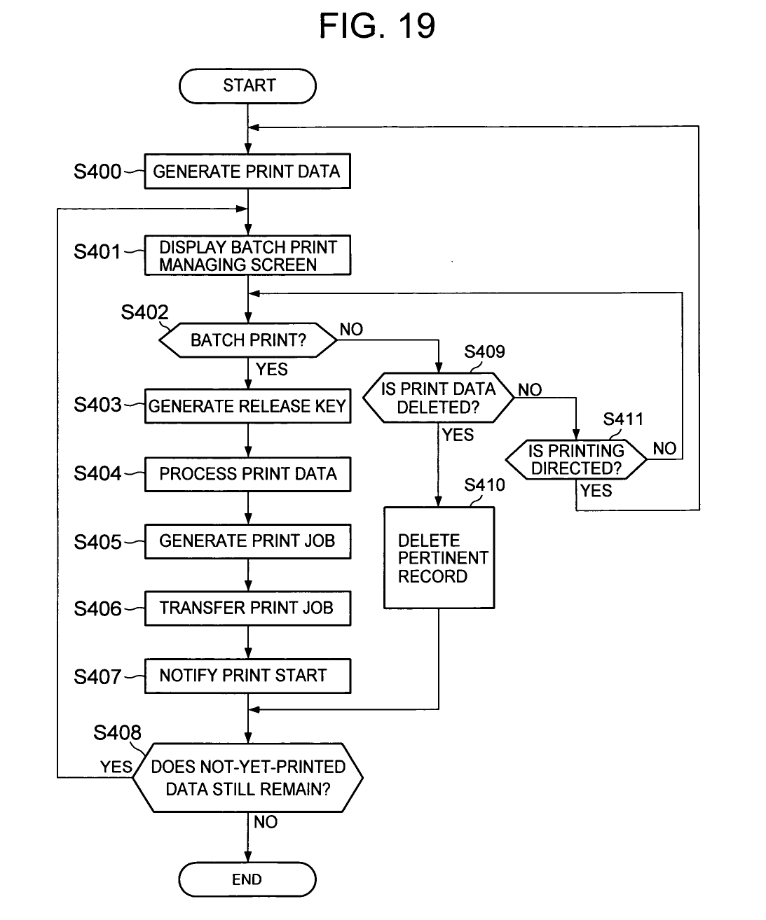

FIG. 19 is a flow chart showing one example of the print processing according to the fourth embodiment. In the case where the application processor 21 accepts a directive for printing from a user via the input device 14, the print managing apparatus 20 starts operations as shown in the flow chart.

Firstly, the application processor 21 outputs generated data such as document data or image data to the print data generator 22, according to a directive from the user. The print data generator 22 converts the data outputted from the application processor 21 into print data, thereby generating the print data (S400).

Then, the print data generator 22 generates the print ID, and stores in the print data storage 28, the print data, the printer name as an output destination, and the file name, in association with the print ID, and sets “0” in the flag associated with the print ID. The print data generator 22 generates a drawing command including the print ID being generated, and sends the drawing command to the virtual printer driver 23.

Next, the virtual printer driver 23 sends the drawing command received from the print data generator 22 to the print manager 30. Then, the print manager 30 directs the display controller 27 to display the batch print managing screen. The display controller 27 refers to the print data storage 28, and displays on the display device 13 the batch print managing screen 44 as shown in FIG. 17, for instance, as to the record 289 in which “0” is set to the flag 287 (S401).

Next, the display controller 27 determines whether or not the batch print button 446 is pressed via the input device 14 in the batch print managing screen 44 (S402). If the batch print button 446 is pressed (S402: Yes), the display controller 27 directs the print manager 30 to perform the batch printing, together with the information about the print ID in association with the check box 440 being selected. Then, the print manager 30 notifies the release key generator 26 about the print ID that is indicated by the display controller 27.

Next, the release key generator 26 refers to the print data storage 28, allocates the print ID being notified from the print manager 30 into a group, the print ID being associated with an identical output destination printer name, and assigns an output ID to each group. Then, the release key generator 26 generates a release key for each group (S403). The release key generator 26 further registers in the print data storage 28 the output ID being assigned and the release key being generated with respect to each group, in association with the print ID within the group.

Next, the release key generator 26 selects one print ID for each group, acquires from the print data storage 28 the print data associated with the print ID being selected, and processes the print data in such a manner that the release key generated for the group and the output ID assigned to the group are printed together with the print data being acquired (S404).

Next, the release key generator 26 overwrites the pertinent print data stored in the print data storage 28 by the print data being processed. After the process of the print data is completed for all group generated for the print ID notified from the print manager 30, the release key generator 26 notifies the print manager 30 that the process of the print data has been completed. Then, the print manager 30 sends the drawing command including the print ID indicated by the display controller 27 to the virtual printer driver 23.

Next, the virtual printer driver 23 sends the drawing command received from the print manager 30 to the printer driver 24. Then, the printer driver 24 acquires from the print data storage 28, the print data associated with the print ID that is included in the drawing command received from the virtual printer driver 23. Then, the printer driver 24 converts the drawing command into a printer description language that can be interpreted by the network printer 11 as an output destination of the print data, generates a print job including the print data to be printed (S405) and sends the print job being generated to the spooler module 25.

Next, the spooler module 25 accumulates the print job received from the printer driver 24, and transfers the accumulated print jobs to the network printer 11, via the communication line 12 (S406). Then, the print manager 30 notifies the display controller 27 of the start of printing (S407).

Next, the print manager 30 refers to the flag 287 of each record 289 within the print data storage 28, and determines whether or not there exists a record 289 in which “0” is set to the flag 287, thereby determining whether or not any print data remains, which has not been printed yet (S408).

If there exists a record 289 in which “0” is set to the flag 287, in other words, if the print data not printed yet still remains (S408: Yes), the print manager 30 executes again the process shown in step S401. If there is no record 289 in which “0” is set to the flag 287, in other words, no print data remains, which has not been printed yet (S408: No), the print managing apparatus 20 completes the print processing as shown in the flow chart.

In step S402, if the batch print button 446 is not pressed (S402: No), the display controller 27 determines whether or not the data deletion button 445 is pressed via the input device 14 in the batch print managing screen 44 (S409). If the data deletion button 445 is pressed (S409: Yes), the display controller 27 directs the print manager 30 to delete data with the information about the print ID associated with the selected check box 440. The print manager 30 deletes from the print data storage 28, the record 289 including the print ID that is indicated by the display controller 27 (S410), and executes the processing as shown in step S408.

If the data deletion button 445 is not pressed (S409: No), the application processor 21 determines whether or not the user has directed printing (S411). If the user has directed printing (S411: Yes), the application processor 21 executes again the processing as shown in step S400. On the other hand, if the user has not directed printing (S411: No), the display controller 27 executes again the processing as shown in step S402.

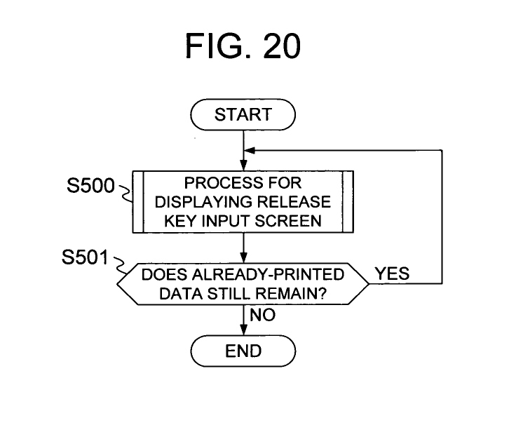

FIG. 20 is a flow chart showing one example of a process for managing the release key input screen, which is executed by the display controller 27. In step S407 of FIG. 19, when the start of printing is notified from the print manager 30, the display controller 27 starts the operations as shown in this flow chart.

Firstly, the display controller 27 executes the process for displaying the release key input screen as explained with reference to FIG. 8 (S500). In step S203 that is referred to in step S500, the display controller 27 refers to the print data storage 28, and displays the release key input screen 45 as shown in FIG. 18 at the forefront, as to the record 289 in which “1” is set to the flag 287.

Then, when execution of step S500 is completed, the display controller 27 refers to the print data storage 28, and determines whether or not the record 289 exists, in which “1” is set to the flag 287, thereby determining whether or not there remains print data whose printing is finished but the valid release key has not been entered yet (S501).

If there exists the record 289 in which “1” is set to the flag 287, in other words, there still remains the print data whose printing has been finished without the valid release key being entered (S501: Yes), the display controller 27 executes again the processing as shown in step S500. On the other hand, When there is no record 289 in which “1” is set to the flag 287, in other words, no more print data remains, which has already been printed but the valid release key is not entered (S501: No), the display controller 27 completes the process for managing the release key input screen as shown in the flow chart.

The fourth embodiment of the present invention has been explained as described above.

According to the print managing apparatus 20 of the present embodiment, when more than one print material is printed by one network printer 11, it is possible to save time and trouble of the user who enters the release key.

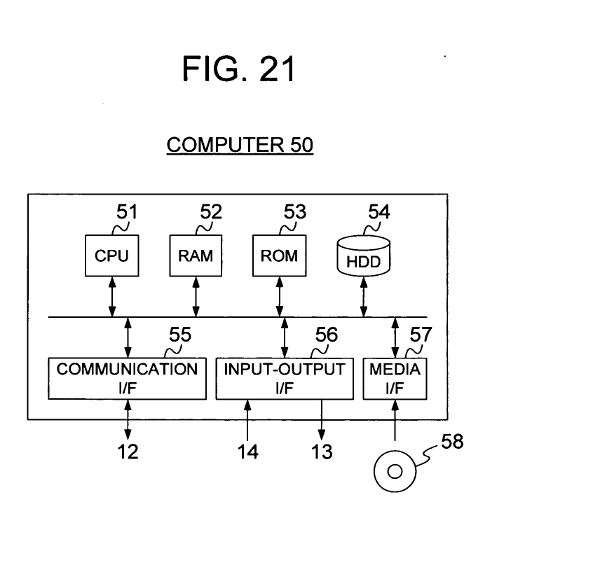

It is to be noted here that the print managing apparatus 20 according to each of the above embodiments may be implemented by a computer 50 having a configuration as shown in FIG. 21, for instance. The computer 50 is provided with a Central Processing Unit (CPU) 51, Random Access Memory (RAM) 52, Read Only Memory (ROM) 53, Hard Disk Drive (HDD) 54, communication interface (I/F) 55, I/O interface (I/F) 56, and media interface (I/F) 57.

The CPU 51 operates on the basis of programs stored in the ROM 53 or in the HDD 54, and controls each part. The ROM 53 stores programs such as a boot program executed by the CPU 51 when the computer 50 starts up, and a program which depends on hardware of the computer 50.

The HDD 54 stores programs executed by the CPU 51 and data used by the programs. The communication interface 55 receives data from other equipment via the communication line 12, and sends the data to the CPU 51, and also sends data generated by the CPU 51 to other equipment via the communication line 12.

The CPU 51 controls the display device 13 such as an LCD, and the input device 14 such as a keyboard or a mouse, via the I/O interface 56. The CPU 51 acquires data from the input device 14 via the I/O interface 56. In addition, the CPU 51 outputs generated data to the display device 13 via the I/O interface 56.

The media interface 57 reads the programs and data stored in a recording medium 58, and provides the CPU 51 with the programs and data via the RAM 52. The CPU 51 loads the programs on the RAM 52 from the recording medium 58 via the media interface 57, and executes the loaded programs. The recording medium 58 may be, for example, a Digital Versatile Disk (DVD), optical recording medium such as Phase change rewritable Disk (PD), a magneto-optic recording medium such as Magneto-Optical disk (MO), a tape medium, a magnetic recording medium, a semiconductor memory, or the like.

When the computer 50 functions as the print managing apparatus 20 according to the first or the second embodiment, the CPU 51 of the computer 50 executes the programs loaded on the RAM 52, thereby implementing each of the functions of the application processor 21, the print data generator 22, the virtual printer driver 23, the printer driver 24, the spooler module 25, the release key generator 26, the display controller 27, and the print data storage 28. In addition, the ROM 53 or the HDD 54 stores the data within the print data storage 28.

When the computer 50 functions as the print managing apparatus 20 according to the third embodiment, the CPU 51 of the computer 50 executes the programs loaded on the RAM 52, thereby implementing each of the functions of the application processor 21, the print data generator 22, the virtual printer driver 23, the printer driver 24, the spooler module 25, the release key generator 26, the display controller 27, the print data storage 28, and the image data storage 29. In addition, the ROM 53 or the HDD 54 stores the data within the print data storage 28 and in the image data storage 29.

When the computer 50 functions as the print managing apparatus 20 according to the fourth embodiment, the CPU 51 of the computer 50 executes the programs loaded on the RAM 52, thereby implementing each of the functions of the application processor 21, the print data generator 22, the virtual printer driver 23, the printer driver 24, the spooler module 25, the release key generator 26, the display controller 27, the print data storage 28, and the print manager 30. In addition, the ROM 53 or the HDD 54 stores the data within the print data storage 28.

The computer 50 reads the programs from the recording medium 58 for execution. As an alternative example, it is possible to acquire these programs from other device via a communication medium. Such communication medium may be represented by the communication line 12, or a digital signal or a carrier wave that propagates through the communication line 12.

The present invention is not limited to each of the embodiments as described above, and various modifications may be possible within the scope of the invention.

By way of example, in the third embodiment described above, when printing is executed, the display controller 27 may display the release key input screen 43 that is not provided with the cancel button 433, at the forefront all over the display area of the display device 13, until a valid release key is entered, in a similar manner as the second embodiment.

Also in the fourth embodiment described above, when printing is executed, the display controller 27 may display the release key input screen 45 that is not provided with the cancel button 454, at the forefront all over the display area of the display device 13, until a valid release key is entered, in a similar manner as the second embodiment.

In the third embodiment as described above, the release key generator 26 selects the image data prepared in advance within the image data storage 29, as image data to be printed together with the print data. However, the present invention is not limited to this.

By way of example, it is possible to configure such that the release key generator 26 generates a random number according to a predetermined rule, every time when a drawing command is received from the virtual printer driver 23, so as to create an image that has a pattern associated with the generated random number. In this case, the release key generator 26 stores the image being created in the print data storage 28, in association with the print ID, and processes the print data associated with the print ID so that the created image and the print ID are printed together with the print data.

For example, it is further possible that the release key generator 26 inputs a bit pattern representing a part of the print data, into a predetermined hash function, and acquires an output from the hash function as the random number. Then, one-dimensional bar code or two-dimensional bar code, which is associated with the acquired random number, may be created as an image that is to be printed with the print data.

The specification and drawings are, accordingly, to be regarded in an illustrative rather than a restrictive sense. It will, however, be evident that various modifications and changes may be made thereto without departing from the spirit and scope of the invention as set forth in the claims.

What is claimed is:

1. A print managing apparatus for allowing a network printer to perform printing of print data indicated by a user, comprising,
a release key generation unit for generating a release key, when printing of the print data is indicated by the user,
a print directive unit for directing the network printer to print the release key being generated by the release key generation unit, together with the print data indicated by the user, and
a display control unit for displaying on a display device, an input screen prompting for the release key, after the print directive unit directs the network printer to print the print data and the release key,
displaying the input screen again on the display device, when a data inputted by the user is different from the release key generated by the release key generation unit, and
canceling to display the input screen, when the data inputted by the user matches the release key generated by the release key generation unit.

2. The print managing apparatus according to claim 1, wherein,
the display control unit displays the input screen at the forefront, all over a display area of the display device.

3. The print managing apparatus according to claim 1, wherein,
the display control unit displays the input screen on the display device at regular time intervals, until the data inputted by the user matches the release key generated by the release key generation unit.

4. The print managing apparatus according to claim 1, further comprising an image storage unit for storing multiple images each serving as the release key, wherein,
the release key generation unit selects as the release key, any one of the images stored in the image storage unit, and
the print directive unit directs the network printer to print the image selected by the release key generation unit, together with the print data indicated by the user,
the display control unit displays the input screen again on the display device, when the image read from a printed material by an image reader coupled to the print managing apparatus is different from the image selected by the release key generation unit, and
cancels to display the input screen, when the image read from the printed material by the image reader matches the image selected by the release key generation unit.

5. The print managing apparatus according to claim 1, wherein,
the release key generation unit generates release keys respectively for output destination network printers, when the user directs a batch printing of multiple print data items,
the print directive unit directs each of the network printers to print the release key being generated, together with the print data items indicated by the user,
the display control unit displays an input screen on the display device, prompting for the release keys respectively for the output destination network printers,
displays the input screen again on the display device, when the data inputted by the user for each of the output destination network printers is different from the release key generated by the release key generation unit for the network printer, and
cancels to display the input screen, when the data inputted by the user for each of the output destination network printers matches the release key generated by the release key generation unit for the network printer.

6. The print managing apparatus according to claim 1, wherein,
the print directive unit further directs the network printer to print a print ID assigned to each print processing, together with the print data indicated by the user and the release key, and
the display control unit displays in the input screen the print ID which is to be printed together with the release key, the release key being expected to be inputted via the input screen.

7. A print managing method in a print managing apparatus for allowing a network printer to perform printing of print data indicated by a user, the print managing apparatus executing the steps of,
generating a release key when printing of the print data is indicated by the user,
directing the network printer to print the release key being generated, together with the print data indicated by the user,
displaying on a display device, an input screen prompting for the release key, and
displaying the input screen again on the display device, when a data inputted by the user is different from the release key being generated, and
canceling to display the input screen, when the data inputted by the user matches the release key being generated.

8. A program for allowing a computer to function as a print managing apparatus that allows a network printer to perform printing of print data indicated by a user, the program allowing the computer to implement,
a release key generating function for generating a release key when printing of the print data is indicated by the user,
a print directive function for directing the network printer to print the release key being generated by the release key generating function, together with the print data indicated by the user, and
a display control function for displaying on a display device, an input screen prompting for the release key, after the print directive function directs the network printer to print the print data and the release key,
displaying the input screen again on the display device, when a data inputted by the user is different from the release key generated by the release key generating function, and
canceling to display the input screen, when the data inputted by the user matches the release key generated by the release key generating function.
